(19) United States
(12) Patent Application Publication
(10) Pub. No.: US 2024/0059140 A1
(43) Pub. Date: Feb. 22, 2024

(54) SHUTTER DEVICE FOR A MOTOR VEHICLE

(71) Applicant: VALEO SYSTEMES THERMIQUES, La Verriere (FR)

(72) Inventors: Frederic VACCA, La Verriere (FR); Enzo MITIDIERI, La Verriere (FR); Karim ARAB, La Verriere (FR); Laura MARION, La Verriere (FR); Victor Manuel MINERO RAMALES, La Verriere (FR); Eng KUACH, La Verriere (FR)

(73) Assignee: VALEO SYSTEMES THERMIQUES, La Verriere (FR)

(21) Appl. No.: 18/546,121

(22) PCT Filed: Feb. 3, 2022
(86) PCT No.: PCT/EP2022/052647

§ 371 Date: Aug. 11, 2023

(30) Foreign Application Priority Data
Feb. 11, 2021 (FR) 2101289

(51) Int. Cl. B60K 11/08

(52) U.S. Cl. CPC B60K 11/085

(57) ABSTRACT

A shut-off device including: a support frame having four sides, a first and second levers configured to be set in motion by an actuator, a first connecting part connected with the first lever, and a second connecting part connected with the second lever, a first set of flaps and a second set of flaps, fastened respectively to the first and second connecting parts. Each flap includes a flap lever arm connecting the flap to the respective first or second connecting part. The first lever includes a primary lever arm connecting the first lever to the first connecting part. The second lever includes a secondary lever arm connecting the second lever to the second connecting part. Each flap lever arm is shorter than any of the primary and secondary lever arms. The first lever and the second lever are connected to one another by a connecting rod.

### TECHNICAL FIELD

The invention relates to shut-off devices for motor vehicles and more particularly to the manners of opening and closing said shut-off devices.

### BACKGROUND OF THE INVENTION

In the field of motor vehicles, a vehicle shut-off device known to a person skilled in the art is disposed behind the grille of the motor vehicles. Such a device comprises, for example, two sets of flaps that can take up an open position and a closed position, the two sets of flaps being opened or closed so as to allow air to pass or to prevent the passage of air under the hood of the engine compartment of the motor vehicles.

A drawback of such a device can exist in relation to the loading of an actuator for opening the flaps.

Specifically, and conventionally, the flaps pivot through an angle equal to around 90° when the shut-off device is being opened. The actuator allowing these motions also pivots through an angle equal to 90°.

If the shut-off device comprises several sets of flaps, and if these sets of flaps open and close asynchronously, the actuator pivots through an angle equal to 90° in order to open and close each set of flaps. In the specific case with two sets of asynchronously opening and closing flaps, the actuator therefore pivots through a total angle equal to 180° to allow the opening or closing of all the flaps.

This results in a significant increase in the number of activations of the actuator (in the above example, the actuator is activate four times per opening and closing cycle of the shut-off device).

Furthermore, the actuator pivots conventionally through 90° each time a set of flaps is opened and closed. This is a normal operating range of a standard actuator used for this type of application (i.e. between 0 and 90°). In other words, the actuator is loaded each time under conditions corresponding to its operating limits.

All this causes a problem of durability of the actuator over time and a potential premature breakdown of the latter, which can prove to be critical given the fact that this actuator makes it possible to open the flaps and therefore allows the passage of air under the hood, in particular toward a heat exchanger.

Lastly, and in the case of a shut-off device comprising a plurality of sets of asynchronously opened and closed flaps, and given that the opening or closing time for a set of flaps (corresponding to the speed of movement of the actuator) is generally around 7 seconds, the time for complete opening or closing of the shut-off device can reach nearly 15 seconds (in the case in which one set of flaps opens or closes only when the other has entirely opened or closed). This results in an actuating time of the shut-off device that is relatively long since it is linked to the speed of rotation of the actuator, which is activated, as explained above, several times during an opening/closing cycle of the shut-off device.

### SUMMARY OF THE INVENTION

The aim of the invention is, in particular, to provide a shut-off device in which the loading of the actuator makes it possible to increase its durability and to reduce the activation time.

Another aim of the invention is to provide a shut-off device that is compact, requiring fewer parts, and is therefore low-cost.

To this purpose, the subject of the invention is a shut-off device for an air intake of a motor vehicle front end, comprising:
a support frame having four sides,
at least one lever configured to be set in motion by an actuator,
at least one connecting part to which the lever is fastened and which is configured to be set in motion by the lever, and
at least one set of rotatable flaps that are fastened to the connecting part and configured to be set in motion between a first, open end position and a second, closed end position by the connecting part, a flap lever arm connecting each flap to the connecting part being shorter than a primary or secondary lever arm connecting the lever to the connecting part.

Thus, and by virtue of the fitting of a lever arm between the lever (set in rotation by the actuator) and the connecting part that is longer than the one that connects this same connecting part to the flaps, the rotational angle of the actuator, which allows rotation through the same angle of the lever, is less than that of the flaps. For example, for a rotational angle of the flaps of 90°, the lever, and consequently the actuator driving the lever, is set in rotation through an angle less than 90° (for example equal to 45° if the lever arm connecting the lever to the connecting part is twice as long as the one connecting each flap to the connecting part). The intensity of the loading of the actuator on each activation for opening or closing the flaps is thus reduced. Hence, and regardless of the number of combined activations of the actuator that are necessary for the operation of the shut-off device, the actuator is preserved on account of a drop in loading intensity on each actuation.

Moreover, and since then angle through which the actuator passes is smaller than according to the prior art, the opening and closing times are shorter (for example divided by two if the lever arm connecting the lever to the connecting part is twice as long as the one connecting each flap to the connecting part). It is possible to vary the speed/torque operating point of the latter in order to adapt it to the difference in lever arm length.

According to further optional features of the shut-off device, taken individually or in combination:
the flap lever arm has a length less than or equal to half the length of the primary or secondary lever arm;
the connecting part is U-shaped, comprising two mutually parallel side walls connected by a third wall forming the bottom of the connecting part;
the flaps are fastened to external faces of the side walls of the connecting part;
the number of flaps is the same on either side of the connecting part;
the lever is fastened to internal faces of the side walls of the connecting part;
the flap lever arm connects the connecting part to an axis of rotation of the flaps and the primary or secondary lever arm connects the connecting part to an axis of rotation of the lever;
the shut-off device also comprises an actuator connected to the lever;
the flap lever arm has a length equal to half the length of the primary or secondary lever arm, the actuator having a speed of between 2 and 15 rotations per minute and a moment of force of between 1 and 6 newton meters;
the lever is secured to an output shaft of the actuator;
the shut-off device comprises:
at least a first and a second set of flaps that can take up an open position and a closed position,
at least two levers configured to be driven by an actuator, and
at least two connecting parts, each connecting part being fastened to a lever and to a set of flaps;
the shut-off device comprises an actuator configured to control the two sets of flaps;
the levers are connected to one another by a connecting rod; A connecting rod is understood to be a one-piece part provided with two articulations, one at each end, in order to transmit a force or a motion. Thus, when one of the levers is driven by the actuator, the motion is transmitted to the other lever without it being necessary to use a second actuator.
the first set of flaps is configured to be opened and closed before the second set of flaps;
each lever comprises a lost motion cam, a spring connecting the two connecting parts;
a first lever is configured to be driven by the actuator and a second lever is configured to be driven by the connecting rod;
the spring is configured to:
be tensioned when the two sets of flaps are in the closed position,
relax so as to position one of the sets of flaps in the open position,
be tensioned when the two sets of flaps are in the open position;
the connecting parts comprise drive fingers configured to come into abutment in the lost motion cams of the levers; and
the sets of flaps are coplanar or one of the sets of flaps extends in a different plane than the other set of flaps.

The invention also relates to a motor vehicle front end module comprising a shut-off device according to the invention.

### BRIEF DESCRIPTION OF DRAWINGS

The invention will be understood better on reading the following description, provided purely by way of example and with reference to the appended drawings, in which:

FIG. 1 is a perspective view of a rear face of a shut-off device according to the invention;

FIG. 2 is a perspective view of the central part of FIG. 1, illustrating the drive mechanism of the shut-off device according to the invention;

FIG. 3 is a simplified view of the drive mechanism illustrated in FIG. 2;

FIG. 4 is a view in section of the drive mechanism of the shut-off device according to the invention;

FIG. 5 is a perspective view of the lower part of the shut-off device in FIG. 3;

FIG. 6 is a perspective view of the upper part of the shut-off device in FIG. 3; and

FIG. 7 is a simplified view of FIG. 6, illustrating the interaction between the lever and the connecting part.

The terms “upper”, “lower”, “left”, “right”, “front”, “rear”, “top” or “bottom” should be understood as referring to the different orientations adopted by an orientation device mounted on a motor vehicle front end module.

### DETAILED DESCRIPTION OF THE INVENTION

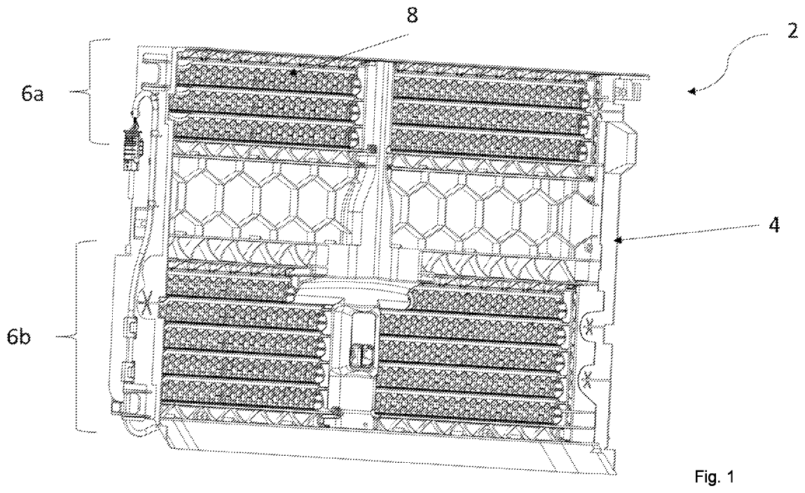

Reference will now be made to FIG. 1, which illustrates the rear face of a shut-off device 2 for an air intake of a motor vehicle front end.

The shut-off device 2, which is also known as an air grille shutter, is disposed behind the grille of the motor vehicle. It is connected to one or more air exchangers and allows air coming from outside the motor vehicle to pass under the hood or to prevent the passage of air under the hood of the motor vehicle.

The shut-off device 2 comprises a support frame 4 that has four sides and supports, as will be shown below, mobile flaps and a drive mechanism for the latter. The support frame 4 can allow the shut-off device 2 to be fastened to a front module of a motor vehicle.

The support frame 4 can also comprise cellular structures extending for example between sets of flaps.

In the example illustrated, the shut-off device 2 comprises two sets 6a and 6b of flaps 8 (only one flap is referenced for the sake of legibility of the figures). In particular, the shut-off device 2 comprises a first set of rotatable flaps 6a and a second set of rotatable flaps 6b. The number of sets of flaps could be different than that in the example illustrated.

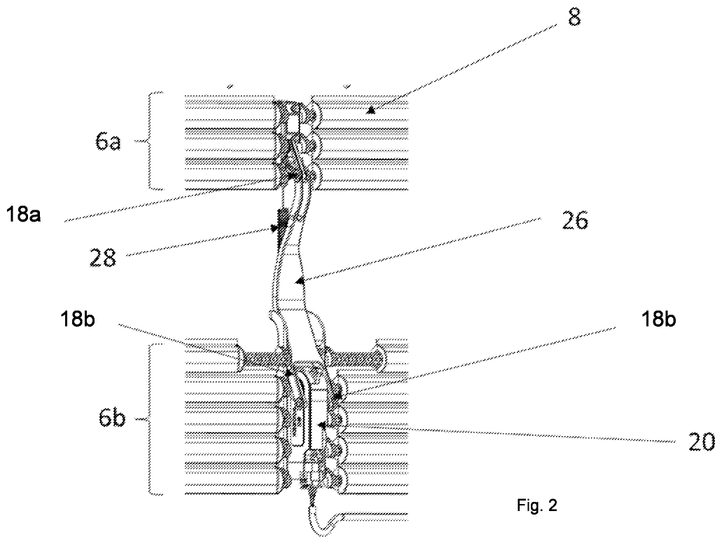

The flaps 8 are rotatable between a first, closed end position (illustrated in the figures) and a second, open end position. An axis of rotation A is illustrated in FIG. 2 for two aligned flaps 18. Conventionally, the rotational angle of the flaps 8 is 90° between these two end positions (this angle could be different).

In the example illustrated, each set of flaps 6a and 6b is divided into two, left-hand and right-hand parts. Each flap 8 of each part comprises an end fastened rotatably to the support frame 4 and another end fastened rotatably to a connecting part 10. These fastenings allow the flaps 8 to rotate, as explained above.

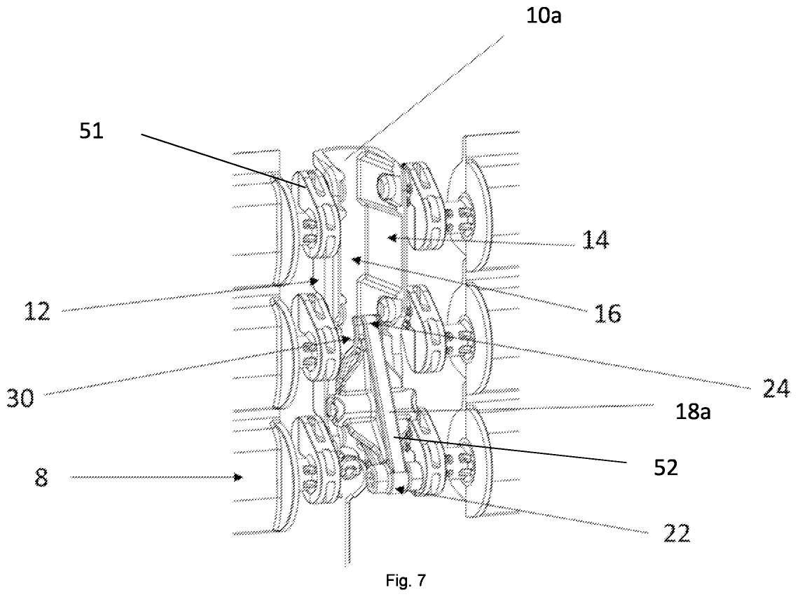

The connecting parts 10 are U-shaped in the example illustrated, comprising two mutually parallel side walls 12 and 14 connected by a third wall 16 forming the bottom of the connecting parts 10. This is clearly visible in FIG. 7 for example. The flaps 8 can be fixed, as illustrated in the figures, for example 5 and 6, to the side walls 12 and 14 of the connecting parts 10. The number of flaps 8 can, as in the example illustrated, be the same on each side of the connecting parts 10.

In the example illustrated, the sets of flaps 6a and 6b are coplanar but could also extend in different planes. The same can be the case for the left-hand and right-hand parts of each set of flaps 6a and 6b.

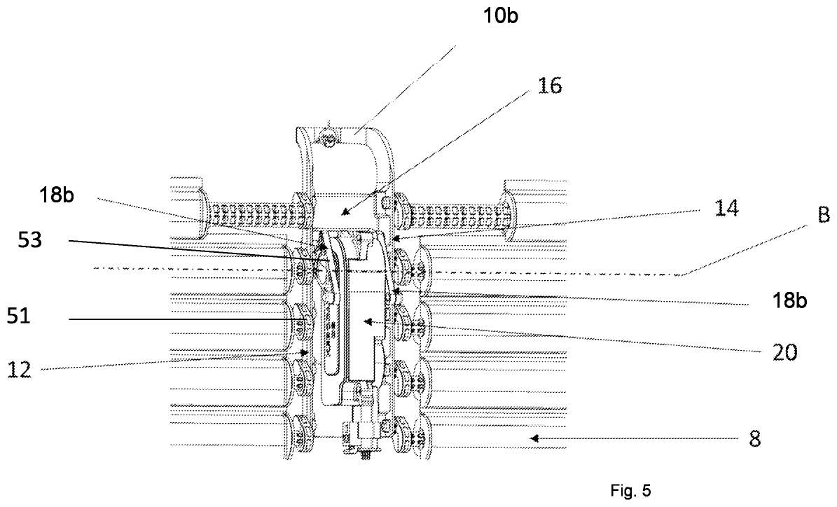

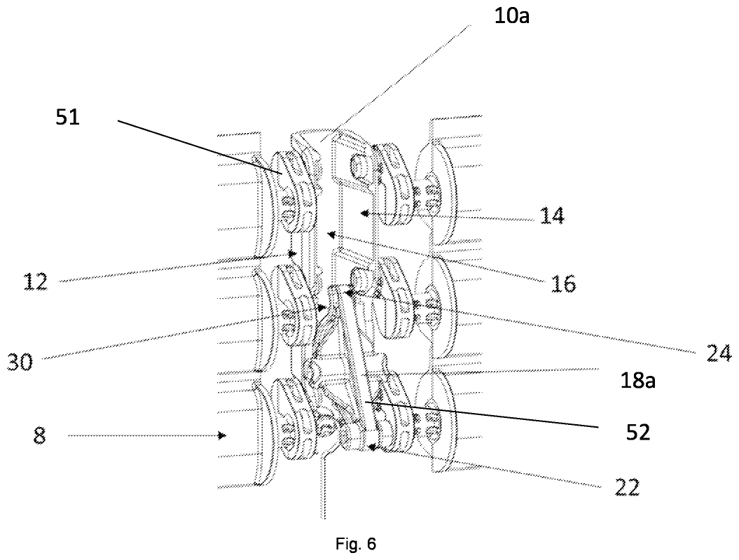

The shut-off device 2 also comprises at least one lever 18, three levers 18 in the example illustrated, which are visible in FIGS. 5 and 6. Each of the levers 18 is designed to be set in motion by an actuator 20, directly or indirectly.

Each lever 18 is fastened to a connecting part 10 so as to be able to set the latter in motion. In the example illustrated in the figures, each lever 18 is fastened to the internal faces of the side walls 12 and/or 14 of the connecting part 10. Still in this example, two levers 18 are secured to an output shaft of the actuator 20 and share the same axis of rotation B, parallel to the axis of rotation A, as that of the output shaft of the actuator 20.

Each lever 18 comprises a first end 22 fastened to a connecting rod 26 and a second end 24 connected to the connecting part 10 (these being visible in FIGS. 6 and 7). Thus, and as will be shown below, the actuator 20 can control the two sets of flaps 6a and 6b.

The shut-off device 2 of the example illustrated therefore comprises a first set and a second set of flaps 6a and 6b, which can take up an open position and a closed position, three levers 18 being able to be driven by an actuator 20, the actuator making it possible to control the two sets of flaps 6a and 6b, and two connecting parts 10 connected, as described above, to the levers 18 and to the flaps 8. A connecting rod 26, visible in FIG. 2, connects the ends 22 of the levers 18 together, the ends 24 of the levers 18 being connected to the connecting parts 10. The levers 18 secured to the actuator 20 are driven with the latter; the lever 18 connected to the connecting rod 26 is driven by the latter.

As explained above, the number of sets of flaps (and of flaps making up a set), of levers, of connecting parts, of actuators can be different than those in the present example.

The generic operation of the shut-off device 2 can be the following:
First of all, the actuator 20 is activated, this resulting in rotation of the output shaft (coincident with the axis of rotation B) of the latter. The levers 18 secured to the axis of rotation of the actuator 20 also pivot.
The connecting part 10 connected to the actuators 18 that have pivoted is also set in motion (circular motion), causing the flaps 8 fastened to this connecting part, in this case the flaps 8 of the set of flaps 6b, to open.
The rotation of the levers 18 secured to the actuator 20 causes the connecting rod 26 to which they are fastened to move (a likewise circular path). This causes the lever 18 not connected to the actuator to rotate, allowing the flaps 8 of the set of flaps 6a to open. The latter sets in motion the connecting part 10 to which it is connected, causing the flaps 8 connected to this connecting part 10 to open.
To close the flaps, the actuator 20 is activated in the opposite direction, causing a series of movements returning the shut-off device 2 to the initial state.

In the case of a plurality of sets of flaps, for example 6a and 6b, the opening of the sets of flaps can be simultaneous or asynchronous (i.e. one set of flaps opening before the other).

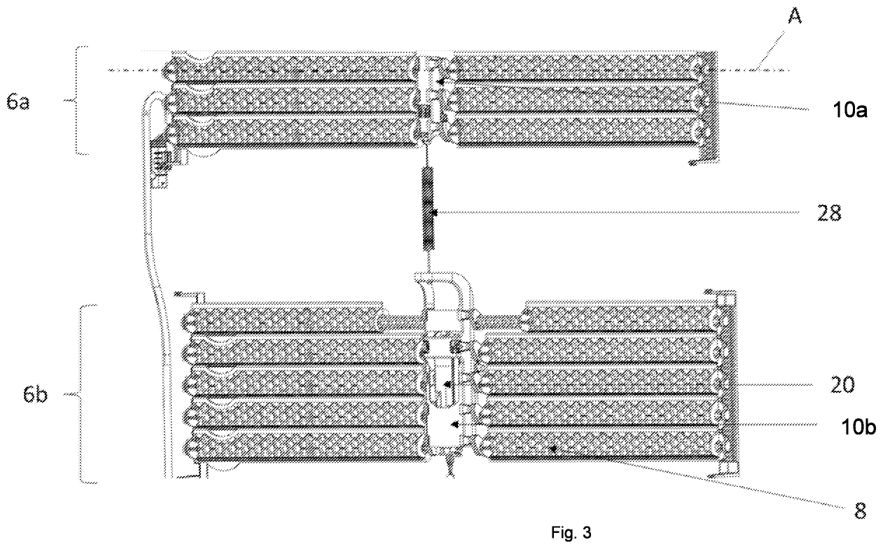

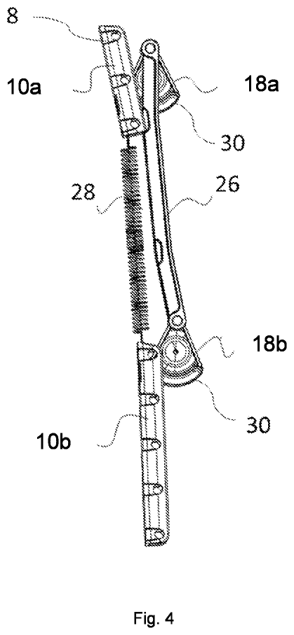

The example illustrated in the figures allows such asynchronous opening. For this, it comprises a tension spring 28, visible in FIGS. 3 and 4, that connects the connecting parts 10 together and is designed to pull the connecting parts toward one another. The tension spring 28 is configured to:
be tensioned when the two sets of flaps 6a and 6b are in the closed position,
relax so as to position one of the sets of flaps in the open position,
be tensioned when the two sets of flaps 6a and 6b are in the open position.

The tension spring could be replaced by any element that makes it possible to fulfill the same functions as the latter.

Moreover, each lever 18 comprises a lost motion cam 30 that can cooperate with a drive finger 32 (visible in FIG. 7) of the connecting parts 10. In other words, a lever 18 will only be able to move a connecting part 10 when the drive finger 32 is in abutment in the lost motion cam. The drive fingers extend, in the example illustrated, from internal faces of the side walls 12 and 14 of the connecting parts 10.

In the scope of asynchronous opening, the method for controlling the shut-off device 2 is the following.

In the initial state, the two sets of flaps 6a and 6b are in the closed state. The tension spring 28 is stretched upward by the connecting part 6a and downward by the connecting part 6b. The drive finger 32 cooperating with the lost motion cam 30 of the lever 18 that is not connected to the actuator 20 is in abutment in said lost motion cam.

The actuator 20 is actuated a first time (first rotation), causing all of the above-described motions in relation to the levers 18 and the connecting rod 26. In this example, the lever 18 that is not connected to the actuator 20 and is set in motion by the connecting rod 26 moves the connecting part 10 with which it cooperates downward (since the drive finger 32 is in abutment in the lost motion cam), causing the flaps 8 of the set of flaps 6a to open. The tension spring 28 relaxes when the connecting part 10 which has been set in motion moves downward (i.e. it is shorter than in the initial state).

As regards the set of flaps 6b, the levers 18 secured to the actuator 20 slide along the drive fingers 32 with which they cooperate without this causing any motion of the connecting part 10 comprising these drive fingers.

In this position, the flaps 8 of the set of flaps 6a are open and those of the set of flaps 6b are closed.

The actuator 20 is activated a second time (second rotation), causing the levers 18 secured to the latter to rotate. Since the drive fingers 32 of the connecting part 10 connected to these levers 18 are in abutment in the lost motion cams 30, the connecting part is moved downward (as was the case for the other connecting part 10 during the first rotation), causing the tension spring 28 to extend again and the flaps 8 of the set of flaps 6b to open.

As regards the set of flaps 6a, the latter remain in the open position. The lost motion cam 30 of the lever 18 at a distance from the actuator 20 slides along the drive finger 32 with which it cooperates (on account of the motion transmitted by the connecting rod 26), without this causing an additional motion of the connecting part 10.

In this position, the two sets of flaps 6a and 6b are open.

As regards the closing of the sets of flaps 6a and 6b, the actuator 20 is activated twice in the opposite direction to the direction allowing them to open, causing the closing of the set of flaps 6b and then that of the set of flaps 6a with a return to the initial state.

In the case of asynchronous opening, it is possible to provide for one set of flaps to open while the other remains closed, and then for the other set of flaps to open. It would also be possible, by acting for example on the length of the lost motion cams 30 and on the angular travel of the actuator 20 during an activation (greater than the length of the lost motion cam 32), for the second set of flaps to start to open while the first set is opening.

According to the invention, a flap lever arm 51 connecting each flap 8 to a connecting part 10 is shorter than a primary or secondary lever arm 52, 52 connecting each lever 18a, 18b to this same connecting part 10.

The flap lever arm 51 corresponds to the distance between the axis of rotation of each flap 8 and its point of attachment to the connecting part 10. The primary or secondary lever arm 52, 52 corresponds to the distance between the axis of rotation of each lever 18a, 18b and its point of attachment to the connecting part (which can be the center of the drive finger 32 cooperating with the lost motion cam 30 in the case described above).

By virtue of this, the lever can pivot through an angle of less than 90° in order to allow the flaps 8 to rotate through 90°. Since the rotation of the levers 18 is identical to that of the actuator 20 (by the latter being directly connected or by force transfer via the connecting rod 26), the output shaft of the actuator 20 therefore pivots through an angle of less than 90°. Given the significant repetition of the number of activation cycles of the actuator 20, in particular in the case of asynchronous opening as described above, such an architecture makes it possible to preserve the actuator 20, which is loaded less on each activation.

The difference in angle covered is proportional to the difference in length between the two lever arms. As explained above, the difference in length of the lever arms allows the flaps 8 to be opened and closed more quickly.

In a preferred case, the flap lever arm 51 has a length equal to half the primary or secondary lever arm 52, 52. In this case, the actuator 20, and consequently the levers 18a, 18b, pivot through an angle equal to 45° to allow the flaps 8 to open through 90°. The speeds at which the flaps 8 open and close are also divided by two. Of course, the length ratio between the two lever arms could be different (the flap lever arm 51 being for example equal to 40% or to 60% of the length of the primary or secondary lever arm 52, 52), and this would consequently modify the difference in angles covered by the flaps 8 for the one part and the levers 18a, 18b and the actuator 20 for the other (the angle covered by the levers 18a, 18b and the actuator 20 would be equal to 40% or to 60% of that covered by the flaps 8).

In the case of asynchronous opening as described above, the actuator 20 is activated twice to allow both sets of flaps 6a and 6b to open.

When the lever arms have an identical length, the actuator 20 needs to effect two rotations through 90°, as do the levers 18a, 18b, to allow a first rotation through 90° of the flaps 8 of the set of flaps 6a and then a second rotation through 90° of the flaps 8 of the set of flaps 6b. The complete rotation of the actuator is therefore 180°. However, the actuators 20 conventionally used in these types of device have an optimal operating range of between 0° and 90°, or even 100°. In other words, and each time the shut-off device is opened/closed, the actuator 20 is loaded in proportions that go beyond its standard operating range, and this could result in premature wearing thereof.

If the length of the flap lever arm 51 is limited to half the primary or secondary lever arm 52, 52, the actuator will carry out only two rotations through 45° at maximum in order for the two sets of flaps 6a and 6b to be opened fully through 90°. This helps to preserve the actuator 20 by making it operate in its optimal operating range.

The actuator 20 and the levers 18a, 18b do not have a starting angle necessarily equal to 0° but, for example, equal to 45° with respect to a longitudinal axis of the connecting parts 10. In the case of a flap lever arm 51 with a length equal to half the primary or secondary lever arm 52, 52, the opening of the first set of flaps 6a causes the actuator 20 and the flaps 18 to pass from this angle of 45° to an angle of 90° and the opening of the second set of flaps 6b causes the actuator 20 and the flaps 18 to pass from this angle of 90° to an angle of 135° (the total angle is thus equal to 90°).

In the prior art, the levers and in particular the lost motion cams are dimensioned so as to allow a rotation of −90° to +90° (with an intermediate position of 0°) since this corresponds to two rotations through 90° of the actuator in one direction and then in the other to open and close the flaps. This range is smaller with a difference in length of the lever arms and proportional to this difference in length. For example, and in the case of a flap lever arm 51 with a length equal to half the primary or secondary lever arm 52, 52, the lost motion cams 30 can carry out a rotation of between −45° and +45° in one direction or in the other in order to open and close the flaps 8. There is therefore a modification of the dimensioning of the levers 18a, 18b.

In order to adapt the actuator 20 to the difference in length of the lever arm, it is possible to redefine the speed/torque operating point of the actuator 20. For example, the speed of the actuator 20 can be between 2 and 15 rotations per minute, preferably between 2 and 4 rotations per minute, and even more preferably equal to 3 rotations per minute, and the moment of force can be between 1 and 6 newton meters, preferably between 1 and 3 newton meters, and even more preferably equal to 1.63 newton meters.

The invention is not limited to the embodiments presented, and further embodiments will be clearly apparent to a person skilled in the art.

In particular, it is possible to modify the number of sets of flaps, of levers or of connecting parts of the shut-off device, and to have synchronized or non-synchronized opening of the different sets of flaps forming the shut-off device.

### LIST OF REFERENCES

2: Shut-off device
4: Support frame
6a, 6b: Sets of flaps
8: Flaps
10a, 10b: Connecting parts
12, 14, 16: Walls of the connecting parts
18a, 18b: Levers
20: Actuator
22, 24: Ends of the levers
26: Connecting rod
28: Tension spring
30: Lost motion cams
32: Drive fingers
51 flap lever arm
52 primary lever arm
53 secondary level arm
A: Axis of rotation of the flaps
B: Axis of rotation of the actuator

What is claimed is:

1. A shut-off device for an air intake of a motor vehicle front end, comprising:
a support frame having four sides,
a first lever and a second lever, both being configured to be set in motion by an actuator,
a first connecting part to which the first lever is fastened and which is configured to be set in motion by the first lever, and a second connecting part to which the second lever is fastened and which is configured to be set in motion by the second lever,
a first set of rotatable flaps and a second set of rotatable flaps, the first and second sets of rotatable flaps being fastened respectively to the first and second connecting parts and configured to be set in motion between a first, open end position and a second, closed end position by the respective first and second connecting part,
wherein each flap of the first and second sets of rotatable flaps includes a flap lever arm connecting said flap to the respective first or second connecting part,
wherein the first lever includes a primary lever arm connecting the first lever to the first connecting part,
wherein the second lever includes a secondary lever arm connecting the second lever to the second connecting part,
wherein each flap lever arm is shorter than any of the primary and secondary lever arms,
wherein the first lever and the second lever are connected to one another by a connecting rod.

2. The shut-off device as claimed in claim 1, wherein the flap lever arm has a length less than or equal to half the length of the primary lever arm.

3. The shut-off device as claimed in claim 1, wherein flaps of the first set of rotatable flaps are situated on either side of the first connecting part and the number of flaps of the first set of rotatable flaps is the same on either side of the first connecting part.

4. The shut-off device as claimed in claim 1, wherein each flap lever arm connects the first connecting part to an axis of rotation of the respective flap of the first set of rotatable flaps and the primary lever arm connects the first connecting part to an axis of rotation of the first lever.

5. The shut-off device as claimed in claim 1, further comprising an actuator, wherein the flap lever arm has a length equal to half the length of the primary lever arm, the actuator being configured to operate at a speed of between 2 and 15 rotations per minute and with a moment of force of between 1 and 6 newton meters.

6. The shut-off device as claimed in claim 1, wherein the first set of rotatable flaps is configured to operate asynchronous with respect to the second set of rotatable flaps.

7. The shut-off device as claimed in claim 1, further comprising the actuator configured to control the first set of rotatable flaps and the second set of rotatable flaps.

8. The shut-off device as claimed in claim 1, wherein the first set of rotatable flaps and the second set of rotatable flaps are coplanar or one of the sets of rotatable flaps extends in a different plane than the other set of rotatable flaps.

9. A motor vehicle front end module comprising
a shut-off device for an air intake of a motor vehicle front end, including:
a support frame having four sides,
a first lever and a second lever, both being configured to be set in motion by an actuator,
a first connecting part to which the first lever is fastened and which is configured to be set in motion by the first lever, and a second connecting part to which the second lever is fastened and which is configured to be set in motion by the second lever,
a first set of rotatable flaps and a second set of rotatable flaps, the first and second sets of rotatable flaps being fastened respectively to the first and second connecting parts and configured to be set in motion between a first, open end position and a second, closed end position by the respective first and second connecting part,
wherein each flap of the first and second sets of rotatable flaps includes a flap lever arm connecting said flap to the respective first or second connecting part,
wherein the first lever includes a primary lever arm connecting the first lever to the first connecting part,
wherein the second lever includes a secondary lever arm connecting the second lever to the second connecting part,
wherein each flap lever arm is shorter than any of the primary and secondary lever arms,
wherein the first lever and the second lever are connected to one another by a connecting rod.

10. The shut-off device as claimed in claim 1, wherein one of the first set of rotatable flaps and the second set of rotatable flaps extends in a different plane than the other.
